(19) United States
(12) Patent Application Publication
(10) Pub. No.: US 2005/0087262 A1
(43) Pub. Date: Apr. 28, 2005

(54) Universal pocket and method for attaching a tooth to a cutter wheel of a tree stump removal machine

(75) Inventor: Lyle J. Clemenson, Brooklyn Park, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Clemenson Enterprises, Inc.

(21) Appl. No.: 10/694,209

(22) Filed: Oct. 27, 2003

(51) Int. Cl. B27C 1/00; B27C 5/00; B26D 1/12; B27G 13/00

(52) U.S. Cl. 144/176; 144/230; 407/34

(57) ABSTRACT

A universal pocket and method for attaching a tooth to a cutter wheel of a tree stump removal machine is described. The pocket includes a pocket body defining opposing wheel and exterior faces, opposing planar leading and trailing edges, a tooth receiving slot, a counter sunk bore, and a threaded bore. The tooth receiving slot is linearly formed in the wheel face and extends between the planar leading edge and the planar trailing edge. The counter sunk bore extends between the exterior face and the wheel face and has an enlarged diameter adjacent to the exterior face. The threaded bore extends between the exterior face and the wheel face. In particular, the bores are located on either side of the tooth receiving slot and equidistant between the planar leading and trailing edges. In this regard, the pocket is symmetric with respect to a line bisecting the bores.

### THE FIELD OF THE INVENTION

The present invention relates to the attachment of teeth to a cutter wheel of a tree stump removal machine. More particularly, it relates to a symmetric pocket for attaching a tooth to a cutter wheel.

### BACKGROUND

Immense horsepower cutting machines have been used for decades in the tree service industry to remove tree stumps from the ground. These immense horsepower cutting machines have a rotating cutter wheel assembly that is repeatedly positioned onto an exposed section of the tree stump to grind the stump into wood chips for subsequent removal. Such cutting machines continue to be the preferred device for removing and recycling tree stumps.

These stump cutting machines generally consist of a motor that rotates a cutter wheel provided with cutting teeth. The cutting teeth are circumferentially mounted around the periphery of the cutter wheel. In particular, the cutting teeth are removably positioned on opposite sides of the cutter wheel and are held in place by a pocket having a bolt/fastener mechanism. In this regard, the cutting teeth are populated on either side of the cutting wheel to assist in efficiently grinding tree stumps. To this end, the pocket is configured to bolt onto a face of the cutter wheel in securing a cutting tooth to the cutter wheel.

A prior art cutter wheel assembly is generally illustrated at 10 in FIG. 1. The prior art cutter wheel assembly 10 includes a cutter wheel 12 having a right face 14, a left face 16, and a leading peripheral edge 18. On the right face 14 is a right hand pocket 20 that is adapted to secure a right hand tooth 22 to the cutter wheel 12. The right hand pocket 20 has a top edge 24 and a leading edge 26. The right hand tooth 22 has a cutting surface 28 that is positioned for unidirectional cutting consistent with a direction of rotation of the cutter wheel 12 as indicated by arrow 29. In a similar manner, a left hand pocket 30 is provided that attaches a left hand tooth 32 to the left face 16 of the cutter wheel 12. The left hand pocket 30 likewise has a top edge 34 and a leading edge 36. The left hand tooth 32 is provided with a cutting edge 38 that is also positioned for unidirectional cutting. As a point of reference, only a single right hand pocket 20/tooth 22 and a single left hand pocket 30/tooth 32 are shown in FIG. 1. In actual practice however, a plurality of these components are provided. In some instances the right hand teeth 22 are angled slightly so as to bend away from the right face 14 and the left hand teeth 32 are angled slightly to bend away from the left face 16. Consequently, the right hand teeth 22 are generally not interchangeable with the left hand teeth 32.

The right hand pocket 20 and the left hand pocket 30 are removably attached to the cutter wheel 12 by a pair of bolts 40 (one of which is shown in FIG. 1) and nuts 42. The bolt 40 is introduced into a lower bolt hole 44 of the right hand pocket 20, pushed through a bore 46 in the cutter wheel 12, and through a lower bolt hole 48 of the left hand pocket 30 prior to engaging with the nut 42. In a like manner, another bolt and nut (not shown) are positioned in upper bores 50 and 52 of the pockets 20, 30, respectively. Finally, upon complete assembly, the cutter wheel assembly 10 rotates unidirectionally as illustrated by arrow 29.

During a cutting operation, the cutting teeth 22, 32 experience wear. Given this situation, the cutting teeth 22, 32 must be replaced periodically. Replacement of the cutting teeth 22, 32 requires removal of the bolts 40 and the nuts 42 that secure the pockets 20, 30 to the cutter wheel 12. In some instances, the pockets 20, 30 will also show wear. For example, pockets 20, 30 worn at the leading edges 26, 36 (i.e., at a forward position adjacent the periphery 18 of the wheel 12) can result in the corresponding respective tooth 22, 32 becoming loose. Accordingly, replacing the right hand tooth 22, for example, will often times also require replacing the right hand pocket 20. Because the pockets 20, 30 have flat leading edges 26, 36, respectively, to provide clearance during cutting, replacement of the pockets 20, 30 requires that the orientation of the leading edges 26, 36 be maintained. Consequently, to replace either worn teeth 22, 32 or worn pockets 20, 30 it is imperative that the leading edges 26, 36 be positioned outward to provide cutting clearance.

Significantly, whenever the prior art pockets 20, 30 are removed, either to replace the teeth 22, 32, or to replace the pockets 20, 30, it is imperative that allowance be made for cutting clearance (i.e., positioning the leading edges 26, 36 adjacent the peripheral edge 18 of the cutter wheel 12). This situation arises because the pockets 20, 30 each have a trailing edge 56, 58, respectively, that is not suited to accommodate the teeth 22, 32, or to provide cutting clearance. Additionally, the pockets 20, 30 can experience uneven wear. Therefore, swapping the right hand pocket 20 to the left face 16, and vice versa, while allowing for cutting clearance, potentially mates pockets 20, 30 having wear that is not proportional to the wear of the teeth 22, 32. This situation poses the problem of potentially loose fitting teeth 22, 32 which is inherently dangerous with these powerful cutting machines. Hence, replacing a worn tooth 22 or 32 requires keeping track of the orientation of the prior art pockets 20, 30, and this is both bothersome and time consuming. Further, if appropriate (i.e., new, or unworn) pockets 20, 30 are not available, then the affected teeth 22, 32 must be taken out of service. Accordingly, the efficiency of the cutter wheel assembly 10 is diminished in the presence of a diminished tooth 22, 32 population.

Immense horsepower stump cutting machines are useful tools for the efficient, economic, and environmentally sound practice of tree stump removal. Because these immense horsepower cutting machines deliver immense torque to the cutting teeth, replacement of the cutting teeth is common. To this end, the efficient and safe replacement of cutting teeth is directly related to the productive operation of the cutting machine. Therefore, a need exits for a universal pocket that is symmetric, offering cutting clearance at both the leading and trailing edges.

### SUMMARY

One aspect of the present invention relates to a universal pocket for attaching a tooth to a cutter wheel of a tree stump removal machine. The pocket defines opposing wheel and exterior faces, opposing planar leading and trailing edges, a tooth receiving slot, a counter sunk bore, and a threaded bore. The tooth receiving slot is linearly formed in the wheel face and extends between the planar leading edge and the planar trailing edge. The counter sunk bore extends between the exterior face and the wheel face and has an enlarged diameter adjacent to the exterior face. The threaded bore extends between the exterior face and the wheel face. In particular, the bores are located on either side of the tooth receiving slot and equidistant between the planar leading and trailing edges. In this regard, the pocket is symmetric with respect to a line bisecting the bores.

Another aspect of the present invention relates to a tool assembly attachable to a cutter wheel of a tree stump removal machine. The tool assembly includes a tooth and a pocket. The tooth has a cutting head and a shank depending from the head. The pocket defines opposing wheel and exterior faces, opposing planar leading and trailing edges, a tooth receiving slot, a counter sunk bore, and a threaded bore. The tooth receiving slot is linearly formed in the wheel face, extending between the planar leading edge and the planar trailing edge, and adapted to couple to the tooth shank. The counter sunk bore extends between the exterior face and the wheel face and has an enlarged diameter adjacent to the exterior face. The threaded bore extends between the exterior face and the wheel face. In particular, the bores are located on either side of the tooth receiving slot and equidistant between the planar leading and trailing edges. In this regard, the pocket is symmetric with respect to a line bisecting the bores.

Yet another aspect of the present invention relates to a method of replacing teeth on a cutter wheel of a stump removal machine. The method includes providing a first pocket attached to a first face of the cutter wheel and a second pocket attached to a second face of the cutter wheel, each pocket defining a tooth receiving slot linearly formed in a wheel face and extending between a planar leading edge and a planar trailing edge, the planar leading edges positioned at a periphery of the cutter wheel. The method additionally includes removing the first pocket and the second pocket from the cutter wheel, and removing the first tooth from the first pocket. The first pocket is rotated by 180 degrees with respect to its tooth receiving slot. A new first tooth is placed into the tooth receiving slot of the first pocket. The first pocket is re-assembled to the first face of the cutter wheel and the second pocket to the second face of the cutter wheel to secure the new first tooth and the second tooth. After attachment, the first planar trailing edge of the first pocket is adjacent the periphery of the cutter wheel.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective view of a prior art cutter wheel assembly;

FIG. 2 is a perspective view of a cutter wheel assembly including symmetric pockets according to one embodiment of the present invention;

FIG. 3 is a perspective view of the two symmetric pockets of FIG. 2 after being rotated by 180 degrees;

FIG. 4 is a view of a wheel face of the pocket illustrated in FIG. 2; and

FIG. 5 is a perspective view of a tool assembly including a universal pocket and tooth according to one embodiment of the present invention.

### DETAILED DESCRIPTION

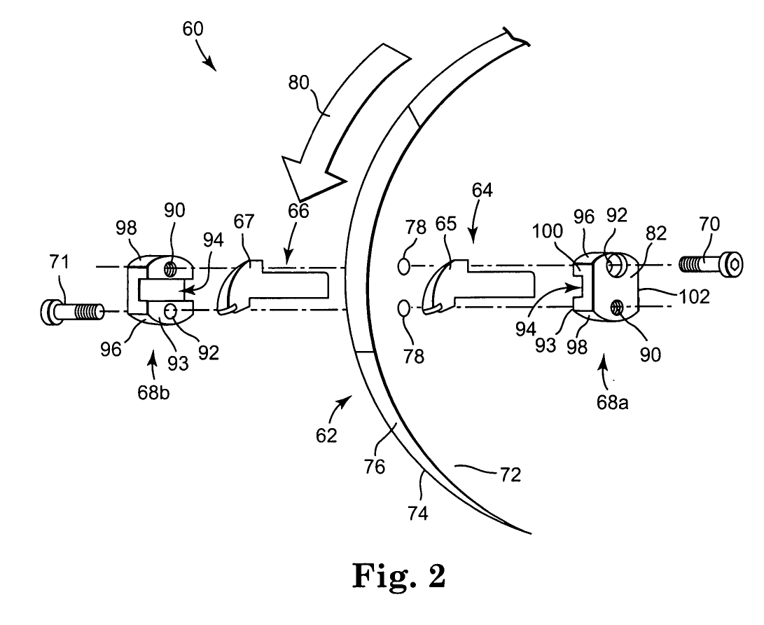

An exemplary cutter wheel assembly according to one embodiment of the present invention is illustrated at 60 in FIG. 2. Generally the cutter wheel assembly 60 includes a cutter wheel 62, a first tooth 64, a second tooth 66, and a pair of pockets 68a and 68b configured to accept and position the teeth 64, 66. The first tooth 64 includes a cutting head 65 and the second tooth 66 includes a cutting head 67. The pockets 68a, 68b are attached to the cutter wheel 62 via bolts 70 and 71 such that the cutting heads 65, 67 project beyond the cutter wheel 62.

The cutter wheel 62 is generally circular and includes a first face 72 and a second face 74 on either side of a peripheral edge 76. In addition, the cutter wheel 62 includes bolt holes 78 and 79 that are configured to accept bolts 70, 71, respectively. In one embodiment, the bolt holes 78, 79 are non-threaded through-holes that permit bolts 70, 71, respectively, to pass through the cutter wheel 62 as they thread into the pockets 68a and 68b, as described below. In any regard, the cutter wheel 62 is typically formed of a hardened metal, for example hardened steel, and is configured to rotate in one direction under high torque provided by an immense horsepower cutting machine (not shown). The uni-directional direction of rotation is indicated by arrow 80.

The pockets 68a and 68b are preferably identical. Specifically, either pocket 68a or 68b is configured to secure either of the first tooth 64 or the second tooth 66 (with the resulting combination of pocket/tooth being referred to herein as a “tool assembly”). In accordance with the present invention, the pockets 68a and 68b have a symmetry that permits their placement on either of faces 72 or 74, or alternately, permits their removal and rotation by 180 degrees prior to replacement on the same faces 72, 74. Given this symmetry, the pocket 68a is described below with the understanding that the pocket 68b is identical in form and function.

The pocket 68a has an exterior face 82 and forms a threaded bore 90 and a counter sunk bore 92. The bores 90, 92 extend perpendicularly through the exterior face 82 to a wheel face 93 (referenced generally in FIG. 2 for the pocket 68a, and more specifically for the pocket 68b). Additionally, a tooth receiving slot 94 is formed that extends along the wheel face 93. In a preferred embodiment, the bores 90, 92 are positioned in mirror image opposition on either side of the tooth receiving slot 94. Upon final assembly, the two pockets 68a, 68b together with the two bolts 70 and 71, secure the two teeth 64, 66 in such a manner that either of the pockets 68a, 68b can be positioned on either the first face 72 or the second face 74 of the cutter wheel 62. That being said, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting.

The universal nature of the pockets 68a, 68b is best described with reference to the various sides or edges defined thereby. More particularly, the pocket 68a defines a counter sunk side 96 adjacent the counter sunk bore 92 and a threaded side 98 adjacent the threaded bore 90. Additionally, the pocket 68a defines a leading edge 100 and a trailing edge 102, the edges 100, 102 intersected by the tooth receiving slot 94. The leading edge 100 and the trailing edge 102 are preferably similarly shaped. That is to say, the leading edge 100 and the trailing edge 102 are substantially planar, and as shown, the edges 100, 102 are substantially parallel to one another. With reference to the orientation of FIG. 2, the pocket 68a is positioned relative to the cutter wheel 62 such that the counter sunk side 96 is topmost and the threaded side 98 is bottom most. Importantly, however, the pocket 68a can be oriented with either the leading edge 100 or the trailing edge 102 adjacent to the cutting heads 65, 67, and thus either edge 100, 102 is positionable adjacent the cuter wheel periphery 76. As a consequence, the pockets 68a and 68b can be selectively positioned on either of the faces 72, 74 to secure and provide cutting clearance for either of the first tooth 64 or the second tooth 66. Therefore, the pockets 68a, 68b are symmetric with respect to the bores 90, 92 and symmetric with respect to the edges 100, 102. In one embodiment, the bores 90, 92 are located equidistant from the edges 100, 102. In a preferred embodiment, the pockets 68a, 68b are also symmetric with respect to the tooth receiving slot 94.

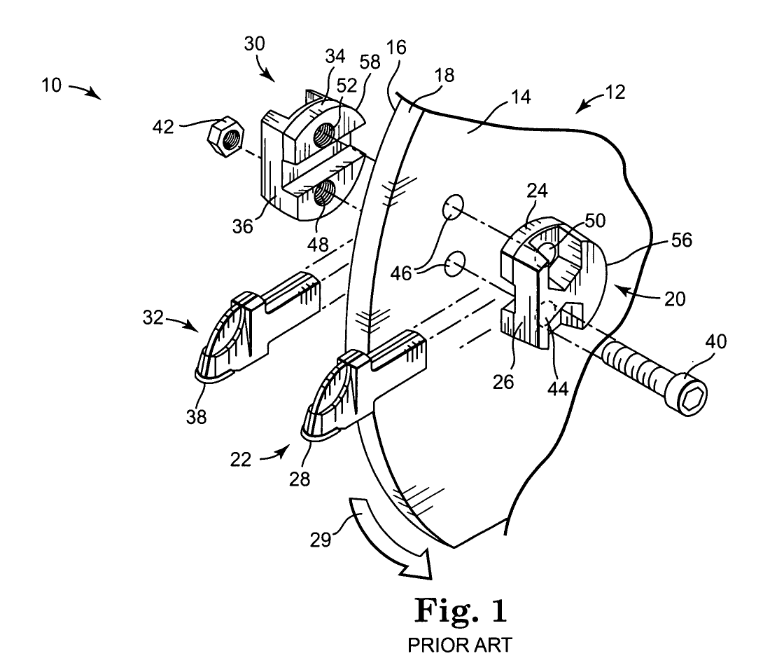

Significantly, the pockets 68a, 68b are configured to provide cutting clearance in either orientation (i.e., either the leading edge 100 adjacent to the peripheral edge 76 or the trailing edge 102 adjacent to the peripheral edge 76). In contrast to the prior art pockets, the pockets 68a, 68b can be rotated 180 degrees with respect to a respective face 72, 74, or the pockets 68a, 68b can be swapped interchangeably between the faces 72, 74. That is to say, the pockets 68a, 68b are universal pockets that are rotatably symmetric about the bores 90, 92 and symmetric about the edges 100, 102. In vivid contrast, the prior art pockets provide cutting clearance in only one orientation (with leading edge 26 outward as in FIG. 1).

The symmetric features of the pockets 68a, 68b can be better understood with a description of the pocket 68b positioned on the second face 74. With reference again to FIG. 2, the pocket 68b is identical to the pocket 68a, the only difference being that the pockets 68a and 68b are rotated 180 degrees with respect to each other. Specifically, the pocket 68b is oriented such that the threaded bore 90 and the threaded side 98 are at the topmost position. Consistent with this rotated orientation, the counter sunk bore 92 and the counter sunk side 96 are at the bottom most position.

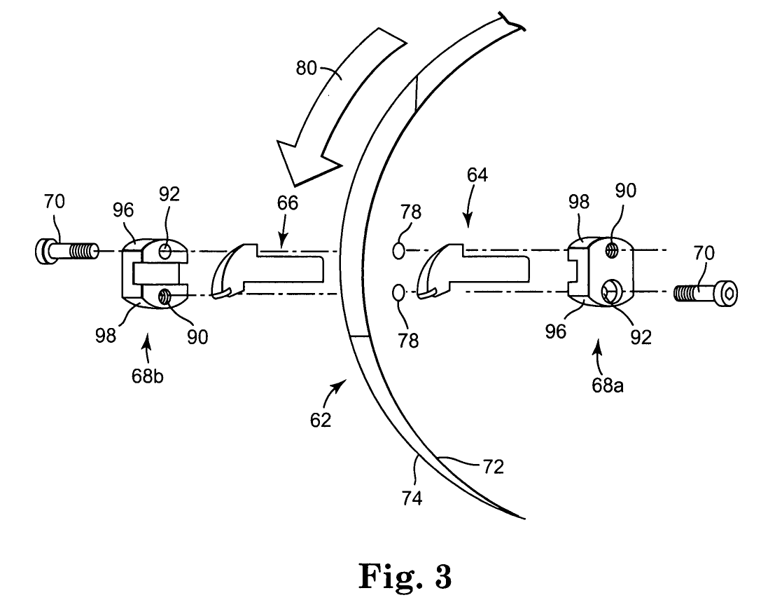

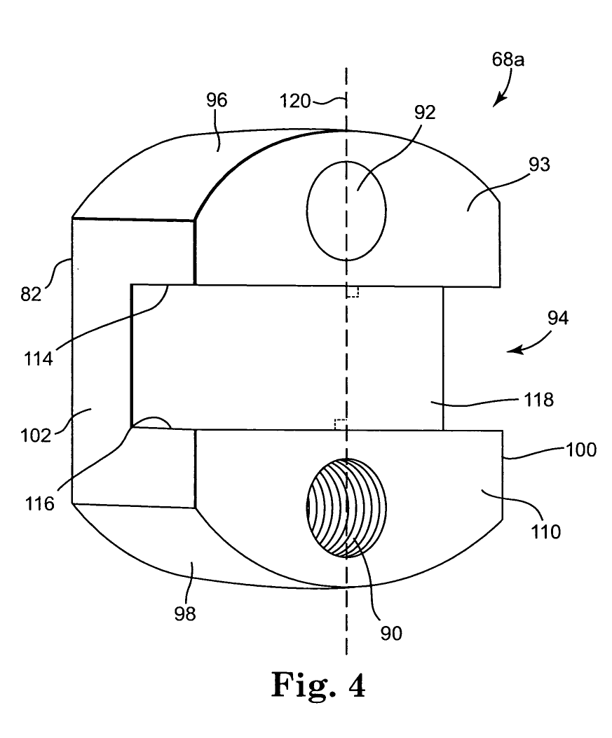

FIG. 3 illustrates an embodiment of the present invention where the pockets 68a and 68b have been rotated by 180 degrees with respect to the bores 90, 92 from the orientation shown in FIG. 2. In particular, FIG. 3 depicts the pocket 68a being oriented such that the threaded bore 90 and the threaded side 98 are at the topmost position. Likewise, the counter sunk bore 92 and the counter sunk side 96 are oriented at the bottom most position. In a similar manner, the pocket 68b has also been rotated by 180 degrees with respect to the orientation shown in FIG. 2. Thus, a comparison of FIGS. 2 and 3 illustrates that the pockets 68a, 68b are rotatably symmetric with respect to bores 90, 92 and symmetric with respect to the edges 100, 102. Upon reading and appreciating this disclosure, one skilled in the art will recognize that the pockets 68a, 68b can be removed from their respective faces 72, 74, rotated by 180 degrees, and re-secured onto their respective faces 72, 74 while providing cutting clearance for the teeth 64, 66. Or alternately, the pockets 68a, 68b can be removed from their respective faces 72, 74, rotated by 180 degrees, and re-secured onto the opposing one of the faces 72, 74 while providing cutting clearance for the teeth 64, 66. The unique pocket 68a is isolated and described in detail in FIG. 4.

Pocket 68a according to one embodiment of the present invention is illustrated in FIG. 4. The pocket 68a is oriented to present the wheel face 93 showing the tooth receiving slot 94. The tooth receiving slot 94 is formed in the wheel face 93 and defines a first slot side 114, a second slot side 116, and a slot base 118. As previously described, the pocket 68a defines the threaded bore 90 and the counter sunk bore 92, the bores 90, 92 extending between the exterior face 82 and the wheel face 93. In one embodiment, the counter sunk bore 92 is non-threaded. In a preferred embodiment, the threaded bore 90 and the counter sunk bore 92 are positioned equidistant between the leading edge 100 and the trailing edge 102 and equidistant below and above, respectively, the tooth receiving slot 94. In this regard, the bores 90, 92 are mirror images of one another. A reference line 120 is shown bisecting the bores 90, 92. In accordance with at least one embodiment of the present invention, the pocket 68a is symmetric with respect to the reference line 120 in a manner that a half of the pocket 68a corresponding with the leading edge 100 is the mirror image of a half of the pocket 68a corresponding to the trailing edge 102. In a preferred embodiment, the pocket 68a is made of drop forged metal having an elastic modulus of greater than 10 million pounds per square inch, for example carbon steel. Alternatively, other construction techniques, such as machining, and/or other materials are equally acceptable.

In one embodiment, the tooth receiving slot 94 is itself symmetric. For example, in one preferred embodiment the first slot side 114 is orthogonal to the slot base 118 and the second slot side 116 is also orthogonal to the slot base 118. In another embodiment, the first slot side 114 intersects with the slot base 118 at an angle between 90 degrees and 180 degrees and the second slot side 116 intersects with the slot base at an angle between 90 degrees and 180 degrees. In an alternate preferred embodiment, the tooth receiving slot 94 defines the sides 114, 116 so as to frictionally accept and conform to a cutting tooth (not shown). In any regard, in a preferred configuration, the first slot side 114 is substantially a mirror image of the second slot side 116, and in this manner, the tooth receiving slot 94 has symmetry.

The pocket 68a is orientated in FIG. 4 with the wheel face 93 exposed, and as such, is an alternate view of the pocket 68a shown in FIG. 2. As positioned in FIG. 4, the leading edge 100 occupies a far side of the view and the trailing edge 102 is in a near side of the view. A better understanding of the function of the universal pocket illustrated in FIG. 4 can be gathered from a description of a tool assembly 130 presented below.

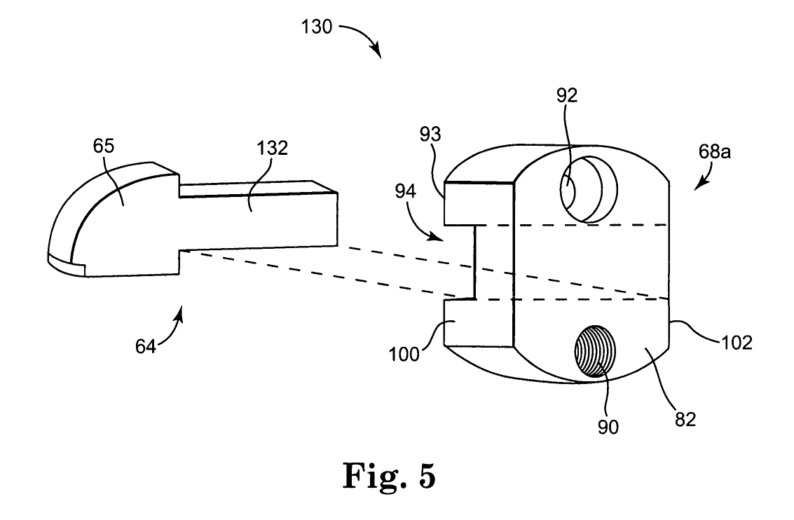

A tool assembly according to one embodiment of the present invention is illustrated at 130 in FIG. 5. The tool assembly 130 includes the tooth 64 and the pocket 68a, it being understood that the tooth 66 (FIG. 2) and the pocket 68b (FIG. 2) are preferably identical. The tooth 64 includes the cutting head 65 and a shank 132 depending from the head 65. As oriented in FIG. 5, the pocket 68a includes the leading edge 100 and the trailing edge 102. As described more completely below, the assembly 130 is novel in that the pocket 68a can accept the tooth 64 in a symmetric manner such that either of the leading or trailing edges 100, 102 can be positioned adjacent to the periphery 76 of the cutter wheel 62 (FIG. 2) to provide cutting clearance for the tooth 64.

The tooth receiving slot 94 is configured to conformably and symmetrically accept the shank 132. In one embodiment, the shank 132 is matingly engaged by the tooth receiving slot 94 as the tool assembly 130 is secured to the cutter wheel 62 (FIG. 2). Specifically, in one embodiment, the leading edge 100 is adjacent to the cutting head 65. However, due to the unique configuration of the pocket 68a, the pocket 68a can be rotated by 180 degrees with respect to the bores (i.e., location of the bore 90 and the bore 92 is reversed) such that the trailing edge 102 can be positioned adjacent to the cutting head 65 as the tool assembly 130 is secured to the cutter wheel 62.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A universal pocket for attaching a tooth to a cutter wheel of a tree stump removal machine, the pocket defining:
opposing wheel and exterior faces;
opposing planar leading and trailing edges;
a tooth receiving slot linearly formed in the wheel face and extending between the planar leading and trailing edges;
a counter sunk bore extending between the exterior face and the wheel face, the counter sunk bore having an enlarged diameter adjacent to the exterior face; and
a threaded bore extending between the exterior face and the wheel face, each bore located on either side of the tooth receiving slot and equidistant between the planar leading and trailing edges;
wherein the pocket is symmetric with respect to a line bisecting the bores.

2. The pocket of claim 1, wherein the planar leading and trailing edges are substantially parallel to one another.

3. The pocket of claim 1, wherein the tooth receiving slot is located equidistant between a central axis of the counter sunk bore and a central axis of the threaded bore.

4. The pocket of claim 1, wherein the tooth receiving slot defines a first slot side, a second slot side and a slot base, the slot sides each forming an angle with the slot base.

5. The pocket of claim 4, wherein the angle is approximately 90 degrees.

6. The pocket of claim 4, wherein the first slot side is a mirror image of the second slot side.

7. The pocket of claim 1, wherein the pocket further defines opposing first and second sides extending between the leading and trailing edges, and further wherein each of the first and second sides are curved.

8. A tool assembly attachable to a cutter wheel of a tree stump removal machine, the tool assembly comprising:
a first tooth including a cutting head and a shank depending from the head; and
a first pocket defining:
opposing wheel and exterior faces;
opposing planar leading and trailing edges;
a tooth receiving slot linearly formed in the wheel face and extending between the planar leading and trailing edges, the tooth receiving slot adapted to receive the shank of the first tooth;
a counter sunk bore extending between the exterior face and the wheel face, the counter sunk bore having an enlarged diameter adjacent to the exterior face; and
a threaded bore extending between the exterior face and the wheel face, each bore located on either side of the tooth receiving slot and equidistant between the planar leading and trailing edges;
wherein the first pocket is symmetric with respect to a line bisecting the bores.

9. The tool assembly of claim 8, wherein the first pocket is adapted to selectively maintain the first tooth at a first position in which the cutting head is adjacent the leading edge and a second position in which the cutting head is adjacent the trailing edge.

10. The tool assembly of claim 8, wherein the leading and trailing edges are substantially parallel to one another.

11. The tool assembly of claim 8, wherein the tooth receiving slot is located equidistant between a central axis of the counter sunk bore and a central axis of the threaded bore.

12. The tool assembly of claim 8, further comprising:
a first bolt including a head and a threaded shaft; and
a second bolt including a head and a threaded shaft;
wherein upon final assembly, the head of the first bolt nests in the counter sunk bore and the threaded shaft is threadably maintained by the threaded bore.

13. The tool assembly of claim 8, wherein the cutter wheel includes a wheel periphery and a first face opposite a second face, the tool assembly further comprising:
a second tooth including a cutting head and a shank depending from the head; and
a second pocket defining:
opposing wheel and exterior faces;
opposing planar leading and trailing edges;
a tooth receiving slot linearly formed in the wheel face and extending between the planar leading and trailing edges, the tooth receiving slot adapted to receive the shank of the second tooth;
a counter sunk bore extending between the exterior face and the wheel face, the counter sunk bore having an enlarged diameter adjacent to the exterior face; and
a threaded bore extending between the exterior face and the wheel face, each bore located on either side of the tooth receiving slot and equidistant between the planar leading and trailing edges;
wherein the first pocket is assembled to the first face and the second pocket is assembled to the second face.

14. The tool assembly of claim 13, wherein each of the first and second pockets are adapted to be mounted to either of the first and second faces of the cutter wheel.

15. The tool assembly of claim 13, wherein the second pocket is further adapted to selectively receive the first tooth and the first pocket is further adapted to receive the second tooth.

16. The tool assembly of claim 13, wherein the second pocket is adapted to, upon assembly to the cutting wheel, provide a first position in which the leading edge of the second pocket is adjacent the wheel periphery and an alternative second position in which the trailing edge of the second pocket is adjacent the wheel periphery.

17. The tool assembly of claim 13, wherein the first and second pockets are identical.

18. The tool assembly of claim 13, further comprising:
a first bolt having a head and a threaded shaft; and
a second bolt having a head and a threaded shaft;
wherein upon final assembly, the head of the first bolt nests within the counter sunk bore of the first pocket and the threaded shaft is threadably engaged by the threaded bore of the second pocket.

19. A method of replacing teeth on a cutter wheel of a stump removal machine comprising:
providing a first pocket attached to a first face of the cutter wheel and a second pocket attached to a second face of the cutter wheel, each pocket defining a tooth receiving slot linearly formed in a wheel face and extending between a planar leading edge and a planar trailing edge, the planar leading edges positioned at a periphery of the cutter wheel;
removing the first pocket from the cutter wheel;
removing the first tooth from the first pocket;
rotating the first pocket by 180 degrees with respect to the tooth receiving slot of the first pocket;
replacing a new first tooth into the tooth receiving slot of the first pocket; and
attaching the first pocket to the first face of the cutter wheel and the second pocket to the second face of the cutter wheel to secure the new first tooth;
wherein after attachment, the planar trailing edge of the first pocket is adjacent the periphery of the cutter wheel.
